(19) United States
(12) Patent Application Publication
(10) Pub. No.: US 2004/0229115 A1
(43) Pub. Date: Nov. 18, 2004

(54) Separation membrane for battery

(76) Inventors: Ga-Lane Chen, Fremont, CA (US); Charles Leu, Fremont, CA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/749,337

(22) Filed: Dec. 31, 2003

(30) Foreign Application Priority Data
Dec. 31, 2002 (TW) 91137954

(51) Int. Cl. H01M 2/18

(52) U.S. Cl. 429/144

(57) ABSTRACT

A separation membrane for a battery includes a number of composite layers (10) attached to each other with adhesive (12). Each composite layer includes a number of molecular layers (14). Each molecular layer comprises carbon atoms (2), and lithium ions (3) intercalated therein.

### BACKGROUND OF THE INVENTION

1. Field of the Invention

The present invention relates to a separation membrane used in a battery, and more particularly to a separation membrane having nanosized holes.

2. Description of Prior Art

Batteries are commonly used in various applications for conversion of chemical energy to electrical energy. Batteries can be broadly categorized into electro-chemical batteries, fuel cells and solar batteries. Electro-chemical batteries can be categorized into primary batteries and rechargeable batteries. Rechargeable batteries such as lithium ion batteries have been in increasing demand in recent years, especially for portable notebook computers, digital cameras, MP3 players, and in mobile phone applications.

As a basic component of a rechargeable battery, a separation membrane plays an important role in determining the capacity, recycle lifetime and current density of the rechargeable battery. The separation membrane is positioned between an anode electrode and a cathode electrode, and allows ions to pass therethrough while blocking electrons from passing therethrough.

A conventional separation membrane is usually made from a polyolefin, such as polyethylene, polypropylene or polystyrene. All of these materials may be harmful to the environment because of their inherent characteristics such as poisonousness, flammability and so on. In addition, during manufacturing of a polystyrene separation membrane, organic solvent containing polystyrene is evaporated and pollutes the environment. Furthermore, polyolefin is a hydrophobic material, and is not dissolved in electrolyte very well. Therefore a separation membrane made from polyolefin cannot absorb large volumes of electrolyte, and has limited capability for transferring ions therethrough. Therefore, the large current charge/discharge performance of a battery with a polyolefin separation membrane is correspondingly limited.

### SUMMARY OF THE INVENTION

Accordingly, an object of the present invention is to provide a hydrophilic separation membrane having great capability of transferring ions.

Another object of the present invention is to provide a battery with a hydrophilic separation membrane having great capability of transferring ions.

In order to achieved the objects set above, a separation membrane in accordance with a preferred embodiment of the present invention comprises a plurality of composite layers attached to each other with adhesive. Each composite layer comprises a plurality of molecular layers. Each molecular layer comprises carbon atoms forming a plurality of hexagon units, and lithium ions intercalated therein. The carbon atoms attract the lithium ions by dangling bonds. A thickness of each composite layer is in the range from 500 nanometers to 500 microns. A thickness of the separation membrane is about 1 millimeter. The separation membrane of the present invention shows hydrophilic characteristics, and is capable of absorption of large volumes of electrolyte. Therefore, the separation membrane can greatly facilitate transmission of lithium ions therethrough.

Other objects, advantages and novel features of the present invention will become more apparent from the following detailed description when taken in conjunction with the accompanying drawings, in which:

### BRIEF DESCRIPTION OF THE DRAWINGS

FIG. 1 is a schematic, isometric view of a separation membrane according to the preferred embodiment of the present invention; and

FIG. 2 is a schematic front elevation of a molecular layer of the membrane of FIG. 1.

### DETAILED DESCRIPTION OF PREFERRED EMBODIMENTS OF THE INVENTION

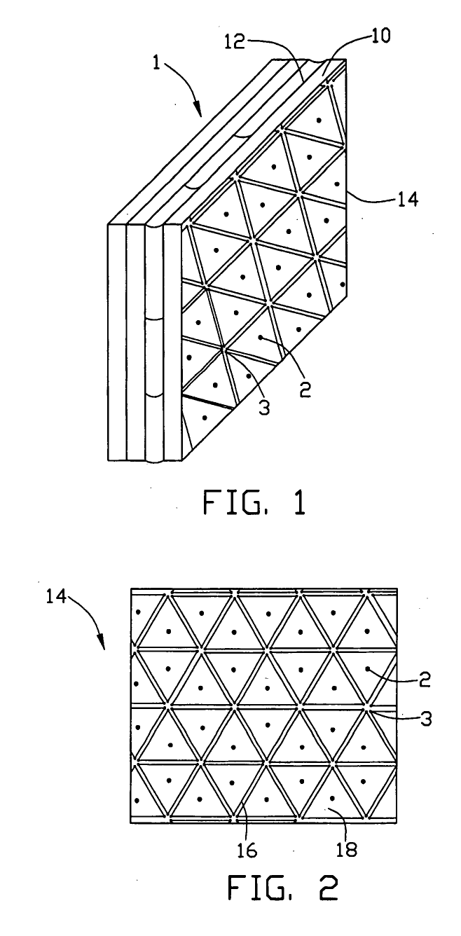

Referring to FIG. 1, a separation membrane 1 in accordance with the preferred embodiment of the present invention is substantially a laminated structure being composed of carbon atoms 2 (C) and lithium ions 3 (Li⁺). The separation membrane 1 comprises a plurality of composite layers 10 attached to each other with adhesive 12. Each composite layer 10 includes a plurality of molecular layers 14. Each two adjacent molecular layers 14 are held together by van der Waals forces. A thickness of each composite layer 10 is in the range from 500 nanometers to 500 microns, and is preferably 100 microns. The number of composite layers 10 is in the range from 5 to 20, and is preferably 10. Therefore, a preferable thickness of the separation membrane 1 is 1 millimeter.

Referring to FIG. 2, each molecular layer 14 substantially comprises a plurality of equilateral triangle units 16. Each equilateral triangle unit 16 has three lithium ions 3 located at three vertexes thereof respectively, and a carbon atom 2 located in a center thereof. A nanohole 18 is defined in a middle of each equilateral triangle unit 16. A length of each side of the equilateral triangle unit 16 is in the range from 25 nanometers to 100 nanometers, and is preferably 50 nanometers. Each carbon atom 2 is Sp hybridized and forms a covalent bond with each neighboring carbon atoms 2. In addition, each carbon atom 2 is capable of attracting lithium ions 3 from electrolyte, because of dangling bonds of the carbon atom 2.

It is noted that from another point of view, each molecular layer 14 comprises a plurality of equilateral hexagon units. Each equilateral hexagon unit has six carbon atoms located at six vertexes thereof respectively, and six lithium ions intercalated therein. A length of a diagonal of the equilateral hexagon which passes through a middle thereof is in the range from 50 nanometers to 200 nanometers, and is preferably 100 nanometers.

It is also noted the molecular layer 14 is preferably made from carbon, yet other materials can be used instead of carbon. For example, materials such as silicon, germanium, silicon carbide, silicon oxide, compositions of carbon and silicon carbide, and compositions of silicon and germanium are also suitable.

The separation membrane 1 of the present invention shows hydrophilic characteristics, and is capable of absorption of large volumes of electrolyte to facilitate transfer of ions therethrough. In addition, each molecular layer 14 having the nanoholes 18 defined therein forms a linked net having a very high cavity density. The linked net structure increases a surface area of the molecular layer 14 and further increases absorption of electrolyte.

It is understood that the invention may be embodied in other forms without departing from the spirit thereof. Thus, the present examples and embodiments are to be considered in all respects as illustrative and not restrictive, and the invention is not to be limited to the details given herein.

1. A separation membrane for a rechargeable battery, comprising:
a plurality of composite layers attached to each other, each of the composite layers comprising a plurality of molecular layers;
wherein each of the molecular layers comprises a plurality of equilateral triangle units, each of which has three lithium ions at three vertexes thereof and a carbon atom at a center thereof.

2. The separation membrane as described in claim 1, wherein the number of the composite layers is in the range from 5 to 20.

3. The separation membrane as described in claim 2, wherein the number of the composite layers is 10.

4. The separation membrane as described in claim 1, wherein a thickness of each of the composite layers is in the range from 500 nanometers to 500 microns.

5. The separation membrane as described in claim 4, wherein the thickness of each of the composite layers is approximately 100 microns.

6. The separation membrane as described in claim 1, wherein a thickness thereof is approximately 1 millimeter.

7. The separation membrane as described in claim 1, wherein a length of each side of each of the equilateral triangle units is in the range from 25 nanometers to 100 nanometers.

8. The separation membrane as described in claim 1, wherein the composite layers are attached to each other with adhesive.

9. A separation membrane for a battery, comprising:
a plurality of composite layers attached to each other, each of the composite layers comprising a plurality of molecular layers;
wherein each of the molecular layers comprises a plurality of equilateral hexagon units, each of which has six carbon atoms located at six vertexes thereof and six lithium ions intercalated therein.

10. The separation membrane as described in claim 9, wherein a length of a diagonal of each of the equilateral hexagons is in the range from 50 to 200 nanometers.

11. The separation membrane as described in claim 10, wherein the length of the diagonal of each of the equilateral hexagons is approximately 100 nanometers.

12. A separation membrane for a rechargeable battery, comprising:
a plurality of composite layers attached to each other, each of the composite layers comprising a plurality of molecular layers;
wherein each of the molecular layers comprises a plurality of equilateral triangle units arranged in an alternative/staggered manner so as to form a hexagonal extension thereof, wherein each of the equilateral triangle units has three lithium ions at three vertexes thereof and means for attracting said three lithium ions at a center thereof.

13. The separation membrane as described in claim 12, wherein said means is carbon, or silicon, and or germanium.

14. The separation membrane as described in claim 12, wherein each of said molecular layers defines silicon carbide, or silicon oxide, or compositions of carbon and silicon carbide, and or compositions of silicon and germanium thereof.

15. The separation membrane as described in claim 12, wherein a diagonal of each equilateral hexagon of said hexagonal extension, which passes through a center thereof, is in a range of 50 nanometers to 200 nanometers.

16. The separation membrane as described in claim 12, wherein each of said equilateral triangle is nanosized.
